(19) United States
(12) Patent Application Publication
(10) Pub. No.: US 2003/0093881 A1
(43) Pub. Date: May 22, 2003

(54) Paper clip

(76) Inventor: Robert Rothman, Stowe, VT (US)

Correspondence Address: Robert Rothman, 147 South Main Street, Stowe, VT, 05672, US

(21) Appl. No.: 09/991,517

(22) Filed: Nov. 21, 2001

(51) Int. Cl. B42F 1/02

(52) U.S. Cl. 24/67.9

(57) ABSTRACT

An improved paper clip design is disclosed. A single paper-thin metal strip folded at a center portion thereof to form a clip with front and rear panels. In the preferred embodiment of the invention, a lower right corner of the front panel and lower left corner of the rear panel are clipped to form a diagonal configuration, functioning to allow for ease in separating the panels when attaching to papers. In this version, the clip further comprises a second, semi-fold line parallel to the main fold, functioning to allow the clip to hold numerous pages or thicker items in a spine formed therein. In all embodiments, the clips of the present invention offer a firm, effective grip upon a variety of items, in a convenient, and easy-to-use manner. Finally, the improved clips of the present invention may be manufactured in a variety of sizes, colors, and designs, to provide aesthetically-pleasing items for the presentation of documents.

### BACKGROUND OF THE INVENTION

1. Field of the Invention

The present invention relates to an improved paper clip design. More particularly, the present invention comprises a single paper-thin metal strip folded at a center portion thereof to form a clip with front and rear panels.

2. Description of the Prior Art

Numerous innovations for paper clips have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 4,949,435, Invented by Michelson, Entitled “Paper Clip”

In the patent to Michelson, an improved paper clip is disclosed consisting of a single piece of wire bent so as to have a straight top spine portion, two straight side leg portions substantially perpendicular to each end of the top spine portion and bent portions extending from, each side leg portion diagonally at approximately 45 degrees in the direction of the top spine portion. Each bent end portion extends from more than ½ the diagonal distance from the end of the side leg portion to the top spine portion.

2. U.S. Pat. No. 5,406,680, Invented by Silverberg, Entitled “Firmly Gripping High Capacity Paper Clip”

The patent to Silverberg describes a family of improved paper clips and a process for their formation which comprises a central bridge leg joining two overlapping and contacting gripping jaws. Each gripping jaw lies in its own plane and controlled torsional forces in the legs comprising the jaws provide for independently controlled gripping forces at multiple tangential contact points. The controlled gripping forces and two layer planar shape result from a substantially elastic transformation from a preceding stepped helix wire form. The advantages include a firm grip on thin or thick packets, the ability to stay flat on thick packets of material, resistance to distortion, special features to aide application to thin or thick packets of material, and modest size facilitating its general purpose use.

3. U.S. Pat. No. 6,163,934, Invented by Crespo Fuster, Entitled “Multi Purpose Paper Clip”

The patent to Crespo Fuster describes a multi-purpose paper clip formed of a strand of flat cross section of a resilient material and has a first loop and a second loop portion that are joined by mutually crossing portions, the first loop portion and second loop portion being of the same hand relative to either crossing portion and being spaced apart in opposed relation so as to form bights facing the crossing portions and each other.

4. U.S. Pat. No. 4,480,356, Invented by Martin, Entitled “Double-Grip Clip”

The patent to Martin describes a double-grip, a one-piece clip formed by having a single piece of wire continuous and bent to form two gripping units on one side of the items desired to be gripped and two gripping units on the other side of the items.

5. U.S. Pat. No. 5,063,640, Invented by Link, Entitled “Endless Filament Paper Clip”

The patent to Link describes a paper clip for securing to at least one sheet of thin material and comprises a continuous or endless filament shaped to provide two oppositely facing pincers. Each oppositely facing pincer has a resilient hinge region connecting and urging together an opposing pair of pincer finger members with each comprising a tip segment, an inner gripping segment, and an outer edge segment. The sheet of thin material is secured between either of the oppositely facing pincers by the inner gripping segments of the pair of opposing pincer finger members.

6. U.S. Pat. No. 6,018,849, Invented by Royer, Entitled “Paper Clip”

The Royer invention is an improved paper clip that comprises a back member having at least two edges that are disposed at substantially right angle to one another, said back member having an extension member from a portion thereof structured to be the upper member that is placed in a clasping manner over the front or upper surface of the grouped papers with the back member placed against a back surface of grouped papers, with perpendicular edges adapted to brace the adjoining side edges of the papers.

7. U.S. Pat. No. 5,870,802, Invented by Goldman, Entitled “Banded Paper Clip”

The Goldman invention describes an improved paper clip consisting of a wire clip integrally wrapped within a folded semi rigid banding allowing for display of printed advertising, promotional, marketing, or decorative indicia, in a multitude of shape and size, as suits the material displayed, while being easier to apply, and remove, while providing protection to the papers to which it is attached from crushing and tearing.

8. U.S. Pat. No. 4,706,342, Invented by Yu, Entitled “Paper Clip”

The Yu invention describes a paper clip formed in one piece and comprises: a top member with an opening, a bottom member having a lower portion and a tilted upper portion integrally connected by a joint portion at their front ends, and a web portion integrally connecting the top member and the lower portion of the bottom member at their rear ends. The upper portion is confined within the opening of the top member and is located in the same plane as the top member when the clip is not being used. The upper portion is resiliently bendable toward the lower portion, and the top and bottom member are separable to receive and hold papers between the entire bodies of the top member and the upper portion. The paper clip has a unique characteristic of distributing a uniform clamping force to the top and bottom members by constantly maintaining a parallel relationship between them.

9. U.S. Pat. No. 4,170,052, Invented by Okerblom, Entitled “Holding Clip”

The Okerblom invention pertains to paper clips, to hold items together temporarily in an organized manner. The object is to provide a wireform holding clip of low profile with substantially greater holding capacity and broad adjustment range to minimize stack buildup due to over extension, to accommodate substantial stack thickness, and to minimize the number of holding clip sizes required to serve a broad range of stack thicknesses.

The aforementioned prior art patents illustrate various paper clip designs including: clips of wire rather than sheets or panels; clips configured in a rounded “figure eight” type pattern; clips designed to “double grip” papers; and clips designed specifically for the corners of pages.

In contrast to the above, the present invention comprises a thin metal strip folded at a center portion to form a clip with front and rear panels. In the preferred embodiment, lower corners of the front and rear panels are clipped to form a diagonal configuration, allowing for ease in separating the panels when in use. The clip comprises a second, semi-fold parallel to the main fold, allowing the same to hold pages in a spine formed therein.

### SUMMARY OF THE INVENTION

As noted above, the present invention relates to an improved paper clip design. More particularly, the present invention comprises a single paper-thin metal strip folded at a center portion thereof to form a clip with front and rear panels.

In the preferred embodiment of the invention, a lower right corner of the front panel and lower left corner of the rear panel are clipped to form a diagonal configuration, functioning to allow for ease in separating the panels when attaching to papers. In the preferred embodiment, the clip further comprises a second, semi-fold line parallel to the main fold, functioning to allow the clip to hold numerous pages or thicker items in a spine or general cavity formed therein.

Thus, the clips of the present invention offer a firm, effective grip upon a variety of items, in a convenient, and easy-to-use manner. Furthermore, the improved clips of the present invention may be manufactured in a variety of sizes, colors, and designs, to provide an aesthetically-pleasing item for the presentation of documents and reports.

In light of the foregoing, it is generally an object of the present invention to provide a clip that holds sheets of paper or the like together in a firm and secure manner.

It is a further object of the invention to provide a clip that is relatively small and lightweight in nature, enabling many such items to be packaged together for user convenience.

It is an additional object of the invention to provide a clip that bears a flat surface upon which advertising, text, or other indicia may be located.

Similarly, it is also an object of the invention to provide a clip that may bear colors or graphics thereon, to enhance the appearance of the clip, and to allow the same to match a report or documents contained therein.

It is a further object of the invention to provide a clip that may be manufactured in any of several sizes, so as to render the invention suitable for a variety of uses.

It is a further object of the present invention to provide a device that is relatively inexpensive to manufacture, produce, and distribute.

Finally, it is an object of the present invention to provide embodiments of the device constructed of alternate materials, such as polymers, according to manufacturer and user needs.

The novel features which are considered characteristic for the invention are set forth in the claims. The invention itself, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

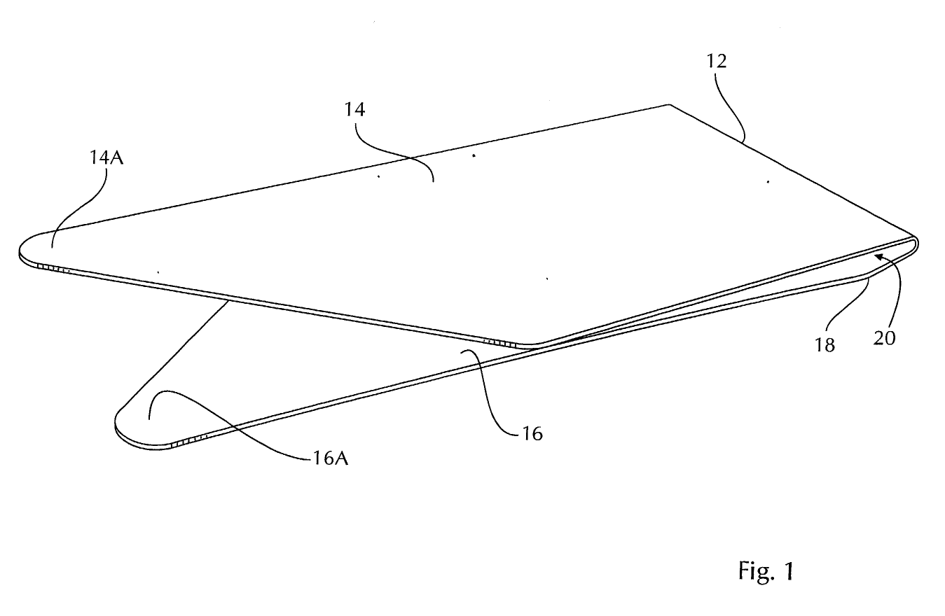

FIG. 1 is a side, three-quarter perspective view of the improved paper clip, illustrating clipped corners of front and rear panels, and proportional size of the device, for the purposes of example only.

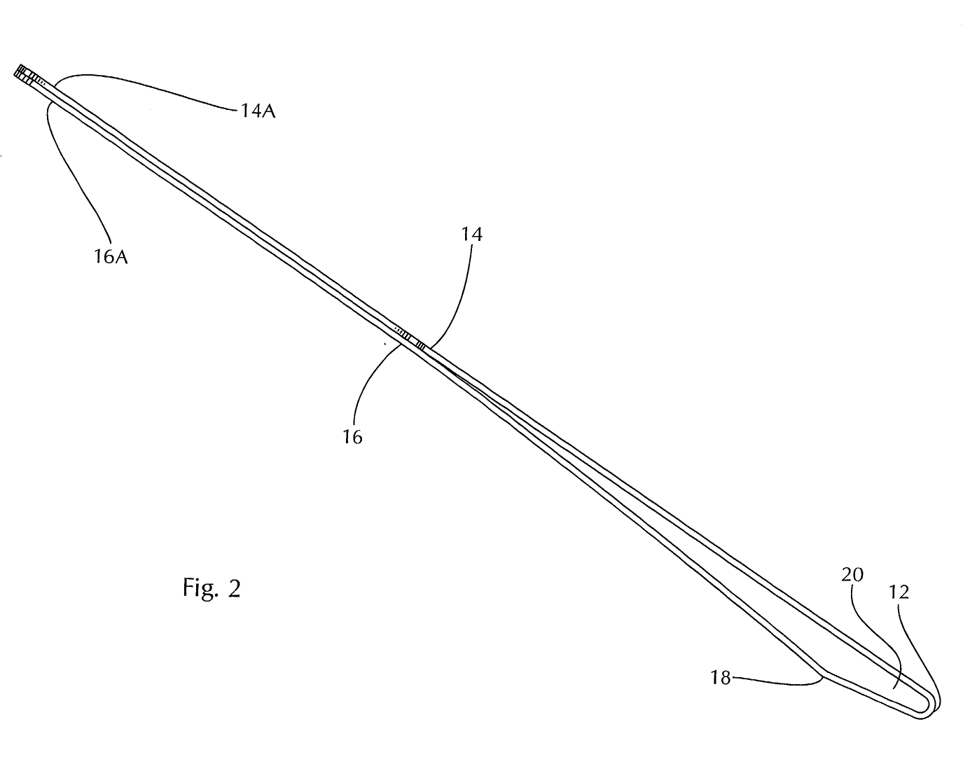

FIG. 2 is a side perspective view of the improved paper clip, illustrating the general depth of the device, including folds that function to allow the clip to hold numerous pages in a spine formed therein.

### DETAILED DESCRIPTION OF THE PREFERRED EMBODIMENT

Referring to both FIG. 1, which is a side, three-quarter perspective view of the improved paper clip, illustrating clipped corners of front and rear panels, and proportional size of the device, for the purposes of example only; and FIG. 2, which is a side perspective view of the improved paper clip, illustrating the general depth of the device, including folds that function to allow the clip to hold numerous pages in a spine formed therein:

The drawings depict the primary fold (12), first panel (14), lower corner of first panel (14A), second panel (16), lower corner of second panel (16A), second fold (18), and cavity formed between the panels at an upper portion thereof (20).

Specifically, the improved paper clip comprises a single paper-thin strip folded at a center portion thereof (12) to form a clip with front and rear panels (14, 16). A lower right corner of the front panel (14A) and lower left corner of the rear panel (16A) are each clipped to form a diagonal configuration. Therefore, when the user views the clip, the lower left corner of the front panel extends downwardly, or points to the bottom of the page. This configuration functions to allow for ease in separating the panels when attaching to documents, and represents a significant difference from the clips of the prior art.

Importantly, a second, semi-fold line (18) is parallel to the main fold, and appears several millimeters from the main fold in the preferred mode of production. This functions to allow the clip to hold numerous pages or thicker items in a cavity (18) formed between the two folds, and thus between the front and rear panels. Specifically, the distance between the folds represents the general thickness of documents and the like that may be effectively held by the clip.

In the preferred mode of production, the clip is constructed of a thin sheet metal, which is durable and relatively inexpensive. However, the improved clip may also be manufactured of a durable plastic or polymeric material for a strong construction at a substantially minimal cost.

Moreover, the clip may be manufactured in a variety of sizes, such as to render the same effective for usage upon a great variety of papers, documents, reports, photographs or a host of other items. For the purposes of example only, in the preferred mode of production, the clip is of a length of 30 mm and of a width of 14 mm. Such is considered an optimal size to render the clip effective for usage upon the greatest variety of documents. In any instance, the size is intended to remain substantially proportional to the embodiment depicted in FIGS. 1 and 2, though minor variations in same may certainly be effective. In certain modes of production, the first panel may extend slightly longer than the second panel, should the manufacturer determine that such a configuration would facilitate placing the clip upon pages and removing the same.

It must also be noted that the distance between the aforementioned two folds may vary in each embodiment, functioning to allow greater or lesser quantities of documents to be held within the clip. Furthermore, the bias and tension of the improved clip may vary, per the thickness of the metal or plastic sheet utilized, functioning to provide greater or lesser grip upon the items held by the clip.

Moreover, as noted, the clip may bear colors, graphics, and indicia thereon to enhance the overall appearance of same. For the purposes of example only, the clip may bears a neon or florescent appearance that is appealing to children and young students.

Therefore, in total, the improved paper clip functions to provide a firm, effective grip upon a variety of items in a convenient, and aesthetically-pleasing manner. With regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the aspects of this invention. What is claimed and desired to be protected by Letters Patent is set forth in the appended claims.

What is claimed is:

1. An improved paper clip comprising:
a single paper-thin strip folded at a center portion thereof to form a clip with front and rear panels;
a lower right corner of the front panel and lower left corner of the rear panel clipped to form a diagonal configuration, functioning to allow for ease in separating the panels when attaching to documents;
a second, semi-fold line upon the rear panel parallel to the main fold, functioning to allow the clip to hold numerous pages or thicker items in a spine formed therein;
the improved paper clip functioning to provide a firm, effective grip upon a variety of items, in a convenient, and easy-to-use manner.

2. The improved paper clip as described in claim 1, wherein the clip is constructed of a thin sheet metal.

3. The improved paper clip as described in claim 1, wherein the clip is constructed of polymers.

4. The improved paper clip as described in claim 1, wherein the clip is manufactured in a variety of sizes.

5. The improved paper clip as described in claim 1, wherein the clip is of a length of 30 mm.

6. The improved paper clip as described in claim 1, wherein the clip is of a width of 14 mm.

7. The improved paper clip as described in claim 1, wherein the clip bears colors, graphics, and indicia thereon.

8. The improved paper clip as described in claim 7, wherein the clip bears a neon or florescent appearance.

9. The improved paper clip as described in claim 1, wherein a distance between the two folds varies, functioning to allow varying sizes and quantities of documents to be held therein.

10. The improved paper clip as described in claim 1, wherein the thickness of the sheet varies, functioning to vary the bias and tension of the clip for increased and decreased strength.

11. The improved paper clip as described in claim 1, wherein the front panel extends to a length greater than that of the rear panel.

12. The improved paper clip as described in claim 1, wherein the rear panel extends to a length greater than that of the front panel.
